(19) United States
(12) Patent Application Publication
(10) Pub. No.: US 2006/0132304 A1
(43) Pub. Date: Jun. 22, 2006

(54) Rule-based management of objects

(76) Inventor: Dennis J. Cabell, Sterling Heights, MI (US)

Correspondence Address: FISH & RICHARDSON P.C., P.O. BOX 1022, MINNEAPOLIS, MN, 55440-1022, US

(21) Appl. No.: 11/005,354

(22) Filed: Dec. 6, 2004

(51) Int. Cl. G08B 1/08; G05B 19/00; G06N 5/02; G08B 13/14; G08B 21/00

(52) U.S. Cl. 340/539.23; 340/686.6; 340/572.1; 340/5.2; 706/46

(57) ABSTRACT

In one general aspect, a first location associated with a first object is identified. A proximity of the first object and a second object are determined based, at least in part, on the first location. A rule associated with the first object and the second object is identified. A violation of the rule is determined based, at least in part, on the proximity of the first object and the second object.

### TECHNICAL FIELD

This invention relates to object management, and more particularly to rule-based management of objects.

### BACKGROUND

An organization's equipment assets (e.g., computers, printers, other objects) are typically managed through conventional means such as by assigning the equipment to an individual or department and using electronic or paper logs for checking in/out an object to indirectly monitor whether the use and/or removal of an object complies with the organization's rules. Generally, such indirect management relies upon individuals to follow operating and reporting procedures (e.g., record activities in a log, following safety procedures) and assumes that the individual accurately and honestly reports necessary information, and continually follows all procedures. For example, an employee of an organization may record either electronically or in a paper log that the employee is removing his assigned laptop from the building. As a result, management generally relies on the record to determine whether the removal and/or use of objects follows specified rules. In addition, there may be a delay between recording activities involving an object and determining whether those activities violate a rule. Such delays preclude the ability to prevent or halt prohibited activities relating to the use or transport of objects during their commission. It is often impractical to manually record the use or movement of objects, especially if they stay on the premises, which creates further reliance on the individual accurately adhering to all operating procedures.

### SUMMARY

In one general aspect, a first location associated with a first object is identified. A proximity of the first object and a second object are determined based, at least in part, on the first location. A rule associated with the first object and the second object is identified. A violation of the rule is determined based, at least in part, on the proximity of the first object and the second object.

Implementations can include one or more of the following features. The determination of the proximity of the first object and the second object is further based, at least in part, on a second location of the second object. The violation of the rule is determined by comparing the proximity the first object and the second object to a proximity threshold. An alert is automatically communicated in response to a violation. The violation of the rule is based, at least in part, on an authorization of an individual.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram illustrating a management system;

FIG. 2 is a block diagram illustrating an alternative implementation of management system; and

FIG. 3 is a flow diagram illustrating a process for determining rule violations of managed objects.

Like reference symbols in the various drawings indicate like elements.

### DETAILED DESCRIPTION

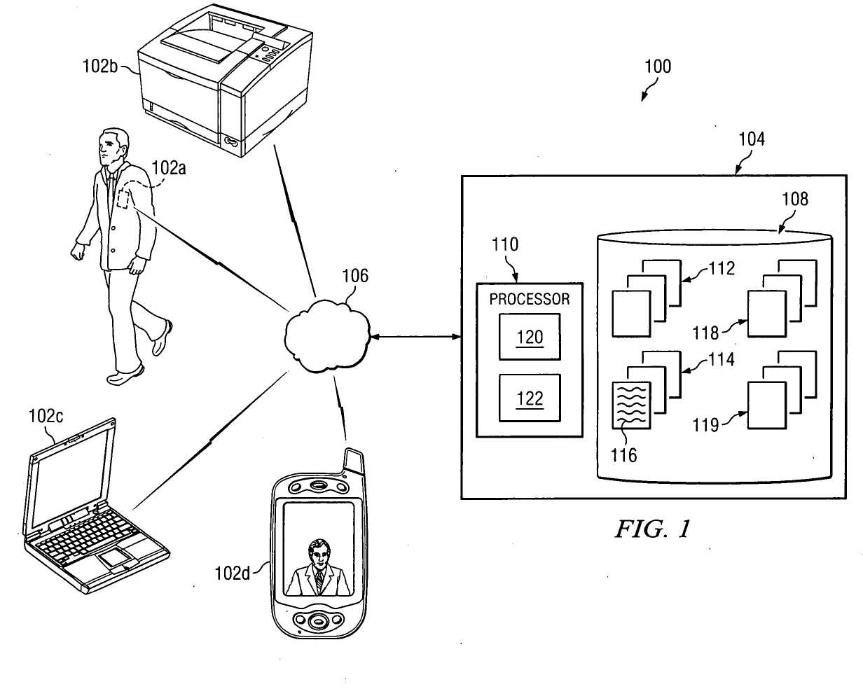

FIG. 1 is a block diagram of an electronic object management system 100. The system 100 operates in a distributed environment and performs rule-based management of objects 102. For example, the system 100 determines whether the use or location of any objects 102 violate an associated rule based, at least in part, on a proximity of other objects 102. A proximity can be defined by information that identifies or may be used to identify relative positions of objects 102. For example, a proximity may identify a distance between a first object 102 and a second 102 object, a presences within a closed area, a radial distance from a selected point, a separation in time between the identification of a first object 102 and a second object 102, and/or any other suitable information that identifies or may be used to identify relative positions of objects 102. In the illustrated example, the objects 102 are connected to a management server 104 through a network 106. But the system 100 may be any other suitable computing environment without departing from the scope of this disclosure. In general, the system 100 records and/or manages the activities involving objects 102 using predetermined rules. As a result, the system 100 using rules that may involve multiple objects 102 may reduce, minimize, or eliminate the unauthorized removal, movement or use of those objects 102.

The server 104 includes a memory 108 and a processor 110. The memory 108 includes location files 112, rulesets 114, authorization files 118, and log files 119. Location files 112 identify location information associated with one or more objects 102. Location information includes information that identifies a specific location or may be used to identify a location. The ruleset 116 provides a rule 116 that defines a rule associated with one or more objects and may be based on a plurality of parameters for example location information. The rule may be based on an authorization of an object 102 stored in an authorization file 118. Turning to the processor 110, the processor 110 includes a location engine 120 for identifying locations of objects and a management engine 122 for determining rule violations regarding the use or transport of one or more objects 102. In general, an object 102 transmits identification information to the server 104 through the network 106. Transmission may be wireless, but may also incorporate other methods (e.g., wireline communication) for transmitting information to server 104. The object 102 may additionally transmit location information or information operable to identify location information. Alternatively or in combination, the network 106 (e.g., RFID reader) may communicate one or more signal strengths associated with the signal transmitted by the object 102 to the location engine 120. Based on the received information, the location engine 120 identifies a location associated with the transmitting object 102, and the management engine 122 identifies a rule 116 associated with the transmitting object 102. In accordance with the rule 116, the management engine 122 determines or otherwise identifies one or more additional objects 102 and locations (or lack thereof) for each object 102. After identifying the locations of the relevant objects 102, the management engine 122 determines or otherwise identifies proximities between the objects 102 and authorizations of objects in accordance with the rule 116. After identifying these parameters, the management engine 122 may determine violations of the rule 116 based on comparing the parameters to the rule 116. In response to determining a violation, the management engine 122 may automatically communicate an alert. The management engine 122 may also record in a log file 119 violations of the rule 116.

The objects 102 can include any software, hardware, and/or firmware operable to wirelessly or otherwise communicate with the network 106. In general, the objects 102 may include any object such as, for example, an access card associated with an individual (102a), a printer (102b), a laptop (102c), artwork (102d), a personal digital assistant (PDA), a mobile phone, a desktop, a flat screen, a picture, a television, or any other object operable to (or including circuitry operable to) transmit signals. In one example, objects 102 comprise mobile objects. For example, the objects 102 may include radio-frequency identification (RFID) tags operable to wirelessly transmit radio-frequency signals to the network 106. The RFID tags may encode identification information in radio-frequency signals such as, for example, information identifying the specific object, a type of object, or any other information such that the server 104 may identify a rule associated with the transmitting object 102. In one implementation, the RFID tags are integrated or otherwise embedded in the objects 102 such that removal of the tags result in material damage to the objects 102. The objects 102 may transmit identification information in response to a signal transmitted by the network 106, periodically (e.g., 1 sec., 5 sec., 30 sec, 1 min., 5 min., etc.), upon detecting any change in condition that warrants transmission of identification information (such as a self-detected change in position, activation of a device, etc.), or otherwise. In summary, the objects 102 include software, firmware, and/or hardware operable to transmit identification information and/or location information to the network 106.

Alternatively or in combination, the objects 102 may include Global Positioning System (GPS) components operable to determine, in near real time, the location of an associated object 102. In one GPS implementation, the objects 102 wirelessly or otherwise transmit location information in addition to identification information to the network 106. Location information includes information that identifies or may be used to identify a location. For example, location information may identify a longitude, a latitude, a time, a street address, a building location, a location within a building, a radial distance around an access point and/or any other information that identifies or may be used to identify a location. The objects 102 may transmit location information in response to a signal transmitted by the network 106, periodically (e.g., 1 sec., 5 sec., 30 sec, 1 min., 5 min., etc.), upon detecting any change in condition that warrants transmission of identification information (such as a self-detected change in position, activation of a device, etc.) or otherwise. The objects 102 may include any other suitable software, firmware, and/or hardware operable to transmit location information to the network 106.

The network 106 facilitates wireless or wireline communication between the server 104 and the objects 102. Indeed, while illustrated as one network 106, the network 106 may be a plurality of communicably coupled networks 106, so long as at least portion of the network 106 may facilitate communications between the objects 102 and the server 104. For example, the object 102 may reside in a wireless intranet that is communicably coupled to the larger network, such as the Internet. In other words, the network 106 encompasses any internal or external network or networks, sub-network, or combination thereof operable to facilitate communications between various computing components in the system 100. The network 106 may communicate, for example, Internet Protocol (IP) packets, Frame Relay frames, Asynchronous Transfer Mode (ATM) cells, voice, video, data, and other suitable information between network addresses. The network 106 may include one or more local area networks (LANs), radio access networks (RANs), metropolitan area networks (MANs), wide area networks (WANs), all or a portion of the global computer network known as the Internet, and/or any other communication system or systems at one or more locations. In one example, at least a portion of the network 106 comprises RFID readers for transmitting wireless signals to and/or receiving wireless signals from the objects 102 to facilitate management by the server 104. For example, the network 106, after receiving a wireless signal from an object 102, determines an associated signal strength and transmits the received information and the associated signal strength to the server 104. Moreover, multiple RFID readers in the network 106 may receive a signal transmitted by an object 102, and thus, the network 106 may transmit the received information and signal strengths associated with multiple RFID readers in the network 106 to the server 104.

The server 104 includes the memory 108 and the processor 110 and is generally an electronic computing device operable to receive, transmit, process and store data associated with the system 100. As briefly discussed above, the memory 108 includes the location files 112, the rulesets 114, the authorization files 118, and the log file 119 but may also include any other appropriate data.

The location file 112 includes one or more entries or data structures operable to identify locations and/or changes in locations associated with the objects 102. The location file 112 may be associated with an object 102, multiple objects 102, a type of object, a group of objects 102, or multiple location files 112 may be associated with a single object 102. For example, the location file 112 may be associated with a single object 102 and stores location information and/or changes in locations of the associated object 102. Moreover, the location file 112 may include one or more of the following: an RFID of the object 102, a type of object 102, a description of the object 102, a relationship to another object 102, a relationship to an individual, and other suitable information. Regarding changes in location, the location file 112 may identify that an associated object 102 entered or exited an area or location such as, for example, a building location, a location within a building, a radial distance around an RFID reader, a radial distance around another object 102, an area associated with an exit or entrance, and/or any other area. Furthermore, the location file 112 may be associated with one or more rulesets 114.

Each ruleset 114 defines rules, instructions, parameters, algorithms, or other directives used by the server 102 to manage the objects 102. The ruleset 114 may be associated with one or more objects 102 and/or one or more location files 112. In general, the processor 110 retrieves rules 116 from the ruleset 114. Each rule 116 is one entry or instruction in the ruleset 114 such that the server 104 may determine a violation of a rule associated with referenced objects 102. The objects 102 may be referenced by identifying specific objects 102, types of objects 102, statuses of objects 102, a group of objects 102, and/or any other reference. In addition, the rule 116 may be based on parameters defining, for example, a specific object 102, a type of object 102, a proximity threshold, an authorization, and/or any other parameter. In one example, the rule 116 identifies a first object 102, a second object 102, and a proximity threshold (e.g., 10 ft.) such that a relative separation that is greater (or alternatively less than) the threshold violates a rule associated with the first object 102 and/or the second object 102. In this example, the rule 116 may require that an object 102 (e.g., an access card) associated with (and on the person of) a former employee must be within 10 ft. of an object 102 (e.g., an access card) associated with (and on the person of) a current employee, thus preventing the former employee from being on the premises unsupervised. In another example, the rule 116 identifies a first object 102, a second object 102, and/or an area such that neither the first object 102 nor the second object 102 may enter (or alternatively exit) the area without the other object or the action violates a rule associated with the first object 102 and/or the second object 102.

Additionally, the rule 116 may also be based on a type of object 102. For example, the rule 116 may identify a type of the first object 102, a second object 102, and a proximity threshold such that a relative separation between the second object 102 and the type of the first object 102 that is greater than (or alternatively less than) the threshold violates a rule associated with the second object 102 and/or the type of the first object 102. Examples of types of objects include a laptop, a personal digital assistant, a mobile phone, a printer, a desktop, a flat screen, artwork, a picture, a television, or any other types. Furthermore, the rule 116 may be based on more than two objects and/or authorizations associated with individuals. For example, the rule 116 may be based on a first object 102, a second object 102, a third object 102, a fourth object 102, and proximities between the various objects 102 such that the first object 102 cannot be greater than (or less than) a first distance from the second object 102 unless the third object 102 associated with a particular authorization is within (or farther than) a second distance from the second object 102 and the fourth object 102 is within (or farther than) a third distance from the first object 102. In this example, the rule 116 may be used to require that two chemical containers may not be within 10 ft. of each other unless an individual that is identified by their access card as having a certain authorization or certification is within the area. In addition, the rule may be based on relative or actual proximities. For example, the rule 116 may require that a first object 102 be closer to a second object 102 than the first object 102 is closer to a third object 102. In comparison, the rule 116 may require that the first object 102 be written 10 ft. of the second object, and the second object must be within 3 ft. of the third object 102, and the third object 102 is within 7 ft. of the first object 102. Additionally, the rule 116 may be based on a group of objects 102. For example, the rule 116 may identify a group of objects 102 associated with a division of an organization. As discussed above, the rule 116 may be based on any parameter and on a plurality of parameters and may be associated with an authorization file 118.

Each authorization files 118 defines rules, instructions, algorithms, certifications, permissions, or any other directive used by the server 104 to determine authorizations granted to an object 102 regarding proximity to other objects 102. An authorization of an object 102 or an authorization file 118 may be referenced in a rule 116, and in response to identifying the reference, the management engine 122 may identify the corresponding authorization file 118. In one example, the authorization file 118 may be associated with an object 102 and identifies specific individuals authorized to use and/or relocate the object 102. In this example, the individuals may be identified by an associated access card such as, for example, object 102a. In another example, the authorization file 118 may be associated with a specific individual and identify specific objects 102, types of objects 102, and/or groups of objects 102 that the individual is authorized to use and/or remove. In this example, the authorization may indicate that an individual associated with an access card is certified to use a type of device. In yet another example, the authorization file 118 may be associated with title and/or position in an organization (e.g., principle, management, etc.) and identifies specific objects 102, types of objects 102, and/or groups of objects 102 that the title is authorized to use and/or remove.

The log file 119 includes one or more entries or data structures operable to identify violations of the rule 116. The log file 119 may be associated with an object 102, multiple objects 102, a type of object, a group of objects 102, or multiple log files 119 may be associated with a single object 102. For example, the log file 119 may be associated with a single object 102 and stores violations and/or information indicating evaluations of the rule 116.

The server 104 also includes the processor 110. The processor 110 executes instructions and manipulates data to perform the operations of the server 104 and may be any processing or computing component such as, for example, a central processing unit (CPU), a blade, an application specific integrated circuit (ASIC), or a field-programmable gate array (FPGA). Although FIG. 1 illustrates a single processor 110 in the server 104, multiple processors 110 may be used according to particular needs and reference to the processor 110 is meant to include multiple processors 110 where applicable. In one example, the processor 110 includes the location engine 120 and the management engine 122 but may include any other suitable processors.

The location engine 120 can include any hardware, software, and/or firmware operable to receive information from objects 102 through the network 106 and determine or otherwise identify a location of the object 102 using the received information. For example, the location engine 120 may receive location information from GPS components of an object 120 identifying a longitude and a latitude. In another example, the location engine 120 may receive one or more signal strengths associated with a signal transmitted by an object 102 and determine location information using the signal strengths. For instance, the location engine 102 may receive three signal strengths each from a different RFID reader and determine a radial distance from each RFID reader using an associated signal strength. Using the these three radial distances, the location engine 102 may triangulate the location of the transmitting object 102. In another instance of using signal strength, the location engine 120 may use a single signal strength associated with an RFID reader to determine a radial distance around the RFID reader for the location of the object 102. In yet another example, the location engine 102 may simply receive information identifying the receiver (e.g., RFID reader) and, using this information, identify an area (e.g., room within a building). Once the location is determined, the location engine 120 may store the information in an associated location file 112.

The management engine 122 can include any software, hardware, and/or firmware operable to determine violations of the rule 116 based on the proximity of two or more objects 102. In one example, the management engine 122 receives or otherwise identifies location information associated with one or more objects 102 and, based on this location information, determine a proximity between the objects 102. The management engine 122 may receive location information from a source, for example, the location engine 120, the location file 112, the network 106, or any other process or file in the server 104, the network 106, or the objects 102. In response to receiving location information or information indicating a change in location of an initial object 102, the management engine 122 may identify a rule 116 associated with the initial object 102. The management engine 122 may identify the rule 116 based on any characteristic of the initial object 102 such as, for example, the specific object 102, a type of the initial object 102, a person associated with the initial object 102, a group associated with the initial object 102, or any other characteristic. Once the rule 116 is identified, the management engine 122 may identify additional objects 102 associated with the initial object 102 in accordance with the rule 116. Once the additional objects 102 are identified, the management engine 122 may determine, retrieve, or otherwise identify location information associated with the additional objects 102 (or lack thereof). Based on this additional location information, the management engine 122 may determine or otherwise identify proximities between the initial objects 102 and the additional objects 102 in accordance with the rule 116. For example, management engine 122 may determine that two objects are within 10 feet. In another example, management engine 122 may determine that the two objects area within a room of a building. In yet another embodiment, management engine 122 may determine that two objects are exiting a building. Additionally, the management engine 122 may identify an authorization of one or more objects 102 in accordance with the rule 116. Based on parameters such as those discussed above, the management engine 122 may determine violations of the rule 116 by, for example, comparing these parameters to the rule 116. In response to determining a violation, the management engine 122 may automatically communicate an alert and/or record the occurrence in a log file 119. The term “automatically,” as used herein, generally means that the appropriate processing is substantially performed by at least a portion of an automated system. For example, an alert may include communicating or issuing a command to sound alarms, lock doors, and/or take photo or video, sending an email to particular personnel, communicating a message to another computer in the network 106, or any other alert. Furthermore, the management engine 122 may continuously trigger the alert for a period of time and then re-evaluate the rule 116 to determine if the objects 102 are still in violation. This process may be performed periodically, and, in response to the objects not violating the rule 116, the management engine 122 may communicate a command to terminate the alert. It will be understood that other mechanisms may be used to re-evaluate the rule 116.

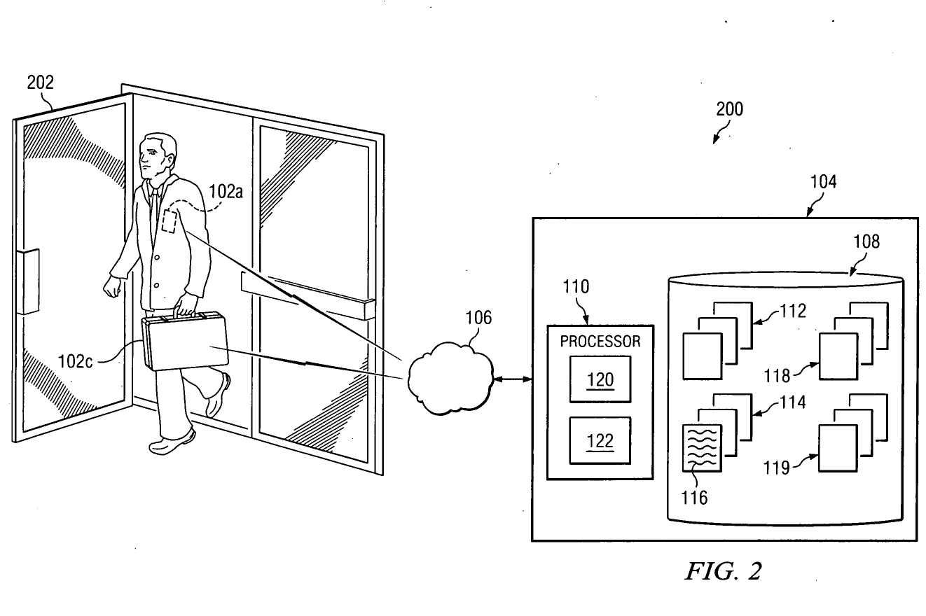

FIG. 2 is a block diagram of a management system 200. The management system 200 includes the features and functions of management system 100 of FIG. 1 as described above, and thus, the elements with like numerals performs the same or analogous features and functions as detailed above in FIG. 1. Furthermore, the management system 200 includes the doorway 202 for preventing the objects 102 from passing through the doorway 202 in violation of a rule 116. In the illustrated example, the object 102a comprises an access card and will be referred to as the access card 102a, and the object 102c comprises a laptop and will be referred to as the laptop 102c.

In one aspect of operation, the access card 102a and the laptop 102c wirelessly transmit identification information to the server 104 through the network 106. The access card 102a and the laptop 102c may additionally transmit location information associated with each object 102. Based on the received information, the location engine 120 identifies a location associated with the access card 102a and the laptop 102c. In response to a change in location of the laptop 102c, the management engine 122 identifies a rule 116 associated with the laptop 102c. In accordance with the rule 116, the management engine 122 determines or otherwise identifies one or more additional objects 102 and locations (or lack thereof) for each object 102. The management engine 122 may identify the access card 102a as such an object 102 based on characteristics such as an RFID, a type, or other characteristics. After identifying the location of the access card 102a, the management engine 122 determines or otherwise identifies a proximity of the access card 102a and the laptop 102c and authorizations associated with the access card 102a in accordance with the rule 116. After identifying these parameters, the management engine 122 may determine violations of the rule 116 by comparing the parameters to the rule 116. For example, the management engine 122 may determine that both the access card 102a and the laptop 102c are within a radial distance of doorway 202 and, thus, may be taken from the area through the doorway 202. In another example, the management engine 122 may determine that while the access card 102c and the laptop 102c are within a threshold, the access card 102c lacks authorization. As a result, management engine 122 may issue a command to lock doorway 202 and, thus, prevent the access card 102a and the laptop 102c from being taken from the area. Alternate responses, which may be included in any combination or alternatively, include an alert to security personnel, storing an indication of a violation in the location file 112, or any other action deemed appropriate.

In an alternative example, the management engine 122 may determine that access cards different from the access card 102a are associated with the laptop 102c. As a result, the management engine 122 may determine that the associated access cards are not within a proximity threshold of the laptop 102c and, thus, the laptop 102c is violating the rule 116. In response to determining a violation, the management engine 122 may automatically transmit a command to lock the doorway 202 and, thus, prevent the individual from leaving the area with the laptop 102c. Alternate responses, which may be included in any combination or alternatively, include an alert to security personnel, storing an indication of a violation in the log file 119, or any other action deemed appropriate.

In yet another alternative example, the management engine 122 may determine that there is an absence of the access card 102a while the laptop 102c is within a defined proximity to the doorway 202. As a result, the management engine 122 may determine that the laptop 102c is violating the rule 116. In response to determining a violation, the management engine 122 may automatically transmit a command to lock the doorway 202 and, thus, prevent the laptop 102c from leaving the area. Alternate responses, which may be included in any combination or alternatively, include an alert to security personnel, storing an indication of a violation in the location file 112, or any other action deemed appropriate.

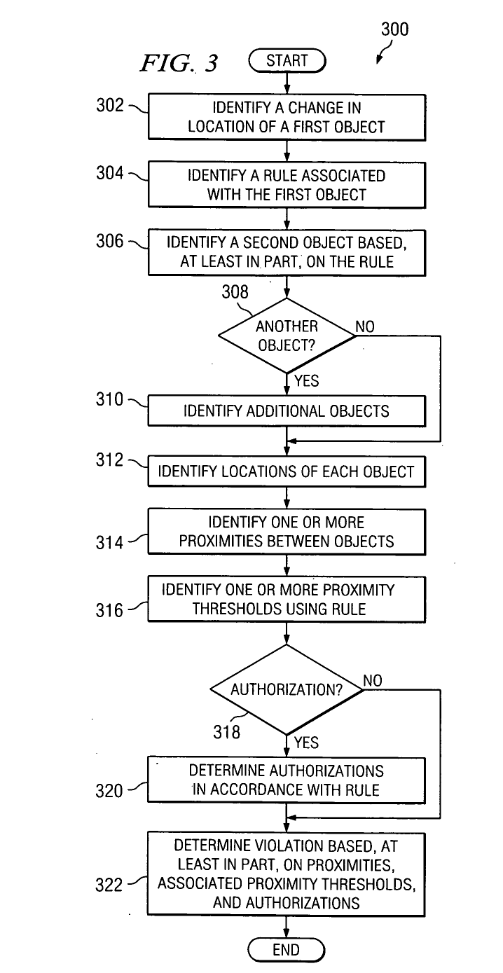

FIG. 3 illustrates a flow diagram implementing an example process for using management system 100 of FIG. 1 to verify activities of an individual. Process 300 is described with respect to management system 100 of FIG. 1, but process 300 could be used by any other application or applications. Thus, many of the steps in this flowchart may take place simultaneously and/or in different orders as shown. Further, management system 100 may execute logic implementing techniques similar to one or both of process 300 in parallel or in sequence. Management system 100 may also use processes with additional steps, fewer steps, and/or different steps, so long as the processes remain appropriate.

Process 300 begins with step 302 where a change in position of a first object is identified. Next, a rule associated with the first object is identified at step 304. It will be understood that a change of any object associated with the rule may trigger the evaluation of the rule. For example, if a rule is associated with an access card, an umbrella, and a laptop, change in location of any of these objects may trigger the evaluation of the rule. In another instance, a change in position of a specific object may trigger the evaluation of the rule. Based, at least in part, on the rule, a second object associated with the rule is identified at step 306. If the rule is associated with additional objects at decisional step 308, then, at step 310, the additional objects are identified. If the rule is not associated with additional objects at decisional step 308, then execution proceeds to step 312. At step 312, a location associated with each object 102 is identified. Next, at step 314, one or more proximities between the objects are determined in accordance with the rule. For example, a proximity between a first object and a second and a proximity between the second object and a third object may be determined in accordance with the rule. One or more proximity thresholds are identified using the rule at step 316. If the rule is associated with authorizations at decisional step 318, then, at step 320, the authorizations are identified in accordance with the rule. If the rule is not associated with authorizations at decisional step 318, then execution proceeds to step 322. At step 322, a violation of the rule is determined based, at least in part, on the proximities, the proximity thresholds, and the authorizations.

The described techniques can be implemented in digital electronic circuitry, integrated circuitry, or in computer hardware, firmware, software, or in combinations thereof. For example, the server 104 may be any computer or processing device such as, for example, a blade server, general-purpose personal computer (PC), Macintosh, workstation, Unix-based computer, or any other suitable device. Generally, FIG. 1 provides merely one example of computers that may be used with the system 100. For example, although FIG. 1 illustrates one server 104 that may be used, the system 100 can be implemented using computers other than servers, as well as a server pool. In other words, the system 100 can include computers other than general purpose computers as well as computers without conventional operating systems. As used in this document, the term “computer” encompasses a personal or handheld computer, workstation, network computer, or any other suitable processing device. The server 104 may be adapted to execute any operating system including Linux, UNIX, Windows Server, or any other suitable operating system.

Apparatus for carrying out the techniques can be implemented in a software product (e.g., a computer program product) tangibly embodied in a machine-readable storage device for execution by a programmable processor; and processing operations can be performed by a programmable processor executing a program of instructions to perform the described functions by operating on input data and generating output. It will be understood that while the location engine 120 and the management engine 122 are illustrated as a single multi-tasked module, the features and functionality performed by this engine may be performed by multiple modules. Further, while illustrated as internal to the server 104, one or more processes associated with the location engine 120 and the management engine 122 may be stored, referenced, or executed remotely. Moreover, the location engine 120 and/or the management engine 122 may be a child or sub-module of another software module (not illustrated) without departing from the scope of this disclosure.

The techniques can be implemented advantageously in one or more software programs that are executable on a programmable system including at least one programmable processor coupled to receive data and instructions from, and to transmit data and instructions to, a data storage system, at least one input device, and at least one output device. Each software program can be implemented in a high-level procedural or object-oriented programming language, or in assembly or machine language if desired; and in any case, the language can be a compiled or interpreted language. For example, each software program may be written or described in any appropriate computer language including C, C++, Java, Perl, Visual Basic, assembler, any suitable version of 4GL, and any other suitable language.

Suitable processors include, by way of example, both general and special purpose microprocessors. Generally, a processor will receive instructions and data from a read-only memory, a random access memory and/or a machine-readable signal (e.g., a digital signal received through a network connection). Generally, a computer will include one or more volatile or non-volatile mass storage devices for storing data files; such devices include without limitation, magnetic media, optical media, random access memory (RAM), read-only memory (ROM), removable media, or any other suitable local or remote memory component. Data may be stored in any suitable format such as, for example, as an eXtensible Markup Language (XML) document, a flat file, comma-separated-value (CSV) file, a name-value pair file, SQL table, an array, an object, or other formats. Furthermore, data may be dynamically created by the biometric device 102 and/or the server 104, a third-party vendor, any suitable user of the biometric device 102 and/or the server 104, loaded from a default file, or received through the network 106. The term “dynamically” as used herein, generally means that the appropriate processing is determined at run-time based upon the appropriate information. Storage devices suitable for tangibly embodying software program instructions and data include all forms of non-volatile memory, including by way of example semiconductor memory devices, such as EPROM (electrically programmable read-only memory), EEPROM (electrically erasable programmable read-only memory), and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the techniques can be implemented on a computer system having a display device such as a monitor or LCD (liquid crystal display) screen for displaying information to the user and a keyboard and a pointing device such as a mouse or a trackball by which the user can provide input to the computer system or a system which enables input and presents information via voice, symbols, or other means such as a Braille input and output system. Interaction with the user can also be accomplished by any device that can provide the appropriate information to a human being, such as an audible alarm or a flashing light. The computer system can be programmed to provide a graphical user interface through which computer programs interact with users. With new technologies such as voice input and output, it is not a requirement to have a visual display to implement the described techniques.

Although this disclosure has been described in terms of certain embodiments and generally associated methods, alterations, and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A method for rule-based management of objects, the method comprising:
identifying a first location associated with a first object;
determining a proximity of the first object and a second object based, at least in part, on the first location;
identifying a rule associated with the first object and the second object; and
determining a violation of the rule based, at least in part, on the proximity of the first object and the second object.

2. The method of claim 1, the method further comprising identifying a second location associated with a second object, wherein the determination of the proximity of the first object and the second object is further based, at least in part, on the second location.

3. The method of claim 1, wherein the proximity comprises one of a distance between the first object and the second object, a presences within a closed area, a radial distance from a selected point, a separation in time between the identification of the first object and the second object, or a combination of the foregoing.

4. The method of claim 1, wherein determining a violation of the rule based, at least in part, on the proximity of the first object and the second object comprises:
identifying a proximity threshold defined by the rule; and
comparing the proximity of the first object and the second object to the proximity threshold.

5. The method of claim 4, wherein determining a violation is based, at least in part, on the proximity of the first object and the second object being greater than the proximity threshold.

6. The method of claim 4, wherein determining a violations is based, at least in part, on the proximity of the first object and the second object being less than the proximity threshold.

7. The method of claim 1, further comprising automatically communicating an alert in response to the violation.

8. The method of claim 1, further comprising identifying a type associated with the first object, wherein determining a violation of the rule is further based, at least in part, on the type of the first object.

9. The method of claim 1, the method further comprising:
determining that the second object is not within a threshold proximity of the first object; and
automatically communicating an alert in response the threshold determination in order to prevent the removal of the first object from an area.

10. The method of claim 1, further comprising:
identifying removal the first object from an area; and
storing an indication of the removal in order to monitor the removal of inventory from the area.

11. The method of claim 1, wherein the first object comprises an individual, the method further comprising identifying authorizations associated with the individual, wherein determining a violation of the rule is based, at least in part, on the authorizations of the individual.

12. The method of claim 1, further comprising identifying an area based, at least in part, on the rule, wherein determining a violation of the rule is based, at least in part, on the area.

13. The method of claim 1, further comprising:
identifying at least one additional object using the rule; and
determining a location associated with each additional object, wherein determining a violation of the rule is further based, at least in part, on the location associated with each additional object.

14. An article comprising a machine-readable medium storing instructions for causing data processing apparatus to perform operations comprising:
identifying a change in location of a first object;
identifying a rule associated with the first object in response to the change in condition;
identifying at least one additional object associated with the first object based, at least in part, on the rule;
determining a proximity of the first object and the at least one additional object; and
determining a violation of the rule based, at least in part, on the proximity of the first object and the at least one additional object.

15. The article of claim 1, the article further performing operations comprising determining a first location of the first object and at least one additional location of the at least one additional object, wherein the determination of the proximity of the first object and the at least one additional object is further based, at least in part, on the at least one additional location.

16. The article of claim 1, wherein the proximity comprises one of a distance between the first object and the at least one additional object, a presences within a closed area, a radial distance from a selected point, a separation in time between the identification of the first object and the at least one additional object, or a combination of the foregoing.

17. The article of claim 1, wherein determining a violation of the rule based, at least in part, on the proximity of the first object and the at least one additional object comprises:
identifying a proximity threshold defined by the rule; and
comparing the proximity of the first object and the at least one additional object to the proximity threshold.

18. The article of claim 17, wherein determining a violation is based, at least in part, on the proximity of the first object and the at least one additional object being greater than the proximity threshold.

19. The article of claim 17, wherein determining a violations is based, at least in part, on the proximity of the first object and the at least one additional object being less than the proximity threshold.

20. The article of claim 17, the article further performing operations comprising automatically communicating an alert in response to the violation.

21. The article of claim 17, the article further performing operations comprising identifying a type associated with the first object, wherein determining a violation of the rule is further based, at least in part, on the type of the first object.

22. The article of claim 17, the article further performing operations comprising:
determining that the at least one additional object is not within a threshold proximity of the first object; and
automatically communicating an alert in response the threshold determination in order to prevent the removal of the first object from an area.

23. The article of claim 17, further comprising:
identifying removal the first object from an area; and
storing an indication of the removal in order to monitor the removal of inventory from the area.

24. The article of claim 17, wherein the first object comprises an individual, the method further comprising identifying authorizations associated with the individual, wherein determining a violation of the rule is based, at least in part, on the authorizations of the individual.

25. The article of claim 17, the article further performing operations comprising identifying an area based, at least in part, on the rule, wherein determining a violation of the rule is based, at least in part, on the area.

26. The article of claim 17, further comprising:
identifying at least one additional object using the rule; and
determining a location associated with each additional object, wherein determining a violation of the rule is further based, at least in part, on the location associated with each additional object.

27. The article of claim 14, wherein the first object comprises a first mobile object, the at least one additional object comprises at least one additional mobile object.

28. A method for managing objects, comprising identifying a change in location of a first object;
identifying a rule associated with the first object in response to the change in condition;
identifying a proximity threshold using the rule;
identifying a second object associated with the first object based, at least in part, on the rule;
determining a first location of the first object and a second location of the second object;
determining a distance between a the first object and the second object;
comparing the distance between a the first object and the second object to the proximity threshold a violation; and
automatically communicating an alert in response to the distance violating the proximity threshold.
